(19) United States
(12) Patent Application Publication
(10) Pub. No.: US 2023/0289222 A1
(43) Pub. Date: Sep. 14, 2023

(54) CONTROL SYSTEM, CONTROL METHOD, AND NON-TRANSITORY STORAGE MEDIUM

(71) Applicants: KYOTO UNIVERSITY, Kyoto-shi (JP); TOKYO INSTITUTE OF TECHNOLOGY, Tokyo (JP); TOYOTA JIDOSHA KABUSHIKI KAISHA, Toyota-shi (JP)

(72) Inventors: Kazuhisa MAKINO, Kyoto-shi (JP); Akitoshi Kawamura, Kyoto-shi (JP); Yasushi Kawase, Tokyo (JP); Hanna Kawase Sumita, Tokyo (JP); Hiromichi Goko, Nagakute-shi (JP)

(73) Assignees: KYOTO UNIVERSITY, Kyoto-shi (JP); TOKYO INSTITUTE OF TECHNOLOGY, Tokyo (JP); TOYOTA JIDOSHA KABUSHIKI KAISHA, Toyota-shi (JP)

(21) Appl. No.: 18/181,061

(22) Filed: Mar. 9, 2023

(30) Foreign Application Priority Data
Mar. 11, 2022 (JP) 2022-037944

(51) Int. Cl. G06F 9/48; G06F 9/46

(52) U.S. Cl. CPC G06F 9/4881; G06F 9/465

(57) ABSTRACT

A control system includes a task assigning unit, a task processing execution unit, and a reassigning unit. The task assigning unit divides a plurality of tasks dispersed in space into a plurality of groups each including one or more tasks and assign the plurality of respective groups to a plurality of respective objects of which states are changeable in the space. The task processing execution unit executes control for causing the respective objects to process the tasks of the assigned group. The reassigning unit assigns, when a processing status of a task satisfies a condition decided in advance, a task of which processing has not been ended in another group to the object that has completed processing of all the tasks of the assigned group.

### CROSS-REFERENCE TO RELATED APPLICATION

This application claims priority to Japanese Patent Application No. 2022-037944 filed on Mar. 11, 2022, incorporated herein by reference in its entirety.

### BACKGROUND

### 1. Technical Field

The present disclosure relates to a control system, a control method, and a non-transitory storage medium.

### 2. Description of Related Art

There is a technology that executes control for causing a plurality of objects to process a plurality of tasks. Regarding this technology, Japanese Unexamined Patent Application Publication No. 2014-059860 (JP 2014-059860 A) discloses a system used for mission re-planning of a robotic vehicle in area search. In JP 2014-059860 A, each of a plurality of vehicles processes an assigned task. A vehicle is monitored in real-time, and an incapacitated vehicle that executes incomplete tasks is detected from among the vehicles. In order to complete the incomplete tasks executed by the incapacitated vehicle, the system appropriately re-plans a predetermined task in real-time and redistributes them to a remaining vehicle such that the remaining vehicle can participate in the task processing (searching).

### SUMMARY

In the technology disclosed in JP 2014-059860 A, in order to complete the incomplete tasks executed by the incapacitated vehicle, the predetermined task is appropriately re-planned in real-time. In such a technology, it may not be possible to efficiently process all tasks.

The present disclosure provides a control system, a control method, and a non-transitory storage medium that can efficiently process all tasks.

A control system according to a first aspect of the present disclosure includes a task assigning unit configured to divide a plurality of tasks dispersed in a space into a plurality of groups each including one or more tasks and assign the respective groups to a plurality of respective objects of which states are changeable in the space, a task processing execution unit configured to execute control for causing the respective objects to process the tasks of the assigned groups, and a reassigning unit configured to, when a processing status of a task satisfies a condition decided in advance, assign a task of which processing is not ended in another group to an object that completes the processing of all the tasks of the assigned group.

With each aspect of the present disclosure, it is highly possible for an object that has completed all tasks to be rearranged to a group for assistance. Therefore, in the present disclosure, it is possible to efficiently process all tasks.

Further, the task assigning unit may execute, before the object starts processing of the task, processing for dividing the tasks into the groups and assigning the respective groups to the respective objects. With such a configuration, once the object starts the processing of the task, a composition of the group is not changed. Therefore, with the aspects of the present disclosure, it is possible to restrict a calculation load and restrict an increase in a calculation time.

Further, the reassigning unit may assign, when the number of objects that complete the processing of all the tasks of the assigned group is equal to or higher than a predetermined number, the task of which the processing is not ended in another group. With such a configuration, it is possible to restrict an increase in a movement time (a movement distance) of the object and restrict an increase in a time for processing the task. Therefore, with the aspects of the present disclosure, it is possible to efficiently process all tasks.

Further, the task processing execution unit may execute control for causing the object that completes the processing of all the tasks of the assigned group to stand by in a predetermined state until a task is reassigned. With such a configuration, the object is restricted from unnecessarily moving. Therefore, with the aspects of the present disclosure, it is possible to restrict the increase in the movement time and the movement distance of the object.

In the first aspect, the reassigning unit may assign, when a certain amount of time elapses since the object completes the processing of all the tasks of the assigned group, the task of which the processing is not ended in another group to the object.

Further, the task assigning unit may divide the tasks into the groups according to an estimated time required for the task. With such a configuration, it is possible to restrict the estimated required time from being biased between groups. Therefore, with the aspects of the present disclosure, it is possible to further restrict the increase in the time for processing the tasks as a whole.

In the first aspect, the estimated time required for the task may be a total of an estimated movement time from a current position of the object to the task and an estimated task processing time estimated to be required for the object to process the task.

Further, a control method according to a second aspect of the present disclosure includes dividing a plurality of tasks dispersed in a space into a plurality of groups each including one or more tasks and assigning the respective groups to a plurality of respective objects of which states are changeable in the space, executing control for causing the respective objects to process the tasks of the assigned groups, and assigning, when a processing status of the task satisfies a condition decided in advance, a task of which processing is not ended in another group to an object that completes processing of all the tasks of the assigned group.

Further, a non-transitory storage medium according to a third aspect of the present disclosure stores instructions that are executable by one or more processors and that cause the one or more processors to execute functions. The functions include dividing a plurality of tasks dispersed in a space into a plurality of groups each including one or more tasks and assigning the respective groups to a plurality of respective objects of which states are changeable in the space, executing control for causing the respective objects to process the tasks of the assigned groups, and assigning, when a processing status of the task satisfies a condition decided in advance, a task of which processing is not ended in another group to an object that completes processing of all the tasks of the assigned group.

With each aspect of the present disclosure, it is possible to provide a control system, a control method, and a non-transitory storage medium that can efficiently process all tasks.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a control system according to a first embodiment;

FIG. 2 is a diagram exemplifying tasks dispersed in a space according to the first embodiment;

FIG. 3 is a diagram illustrating a configuration of a control device according to the first embodiment;

FIG. 4 is a flowchart illustrating a control method executed by a control system according to the first embodiment;

FIG. 5 is a flowchart illustrating an example of task assigning processing of a task assigning unit according to the first embodiment;

FIG. 6 is a diagram for describing a first specific example;

FIG. 7 is another diagram for describing the first specific example;

FIG. 8 is yet another diagram for describing the first specific example;

FIG. 9 is a diagram for describing a second specific example;

FIG. 10 is another diagram for describing the second specific example;

FIG. 11 is yet another diagram for describing the second specific example;

FIG. 12 is still yet another diagram for describing the second specific example;

FIG. 13 is still yet another diagram for describing the second specific example;

FIG. 14 is still yet another diagram for describing the second specific example;

FIG. 15 is still yet another diagram for describing the second specific example;

FIG. 16 is a flowchart illustrating a control method executed by a control system according to a second embodiment; and

FIG. 17 is a diagram exemplifying a virtual space in which tasks are dispersed according to a modified example.

### DETAILED DESCRIPTION OF EMBODIMENTS

### First Embodiment

Hereinafter, embodiments of the present disclosure will be described with reference to drawings. For clarity of description, the following descriptions and drawings are omitted and simplified as appropriate. Further, in each drawing, the same components are denoted by the same reference signs, and redundant description is omitted as necessary.

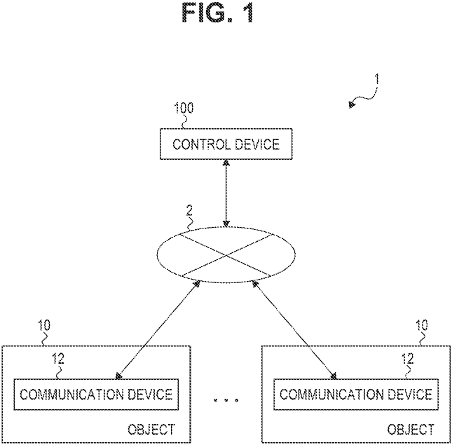

FIG. 1 is a diagram illustrating a control system 1 according to a first embodiment. The control system 1 includes a communication device 12 corresponding to each of a plurality of objects 10, and a control device 100. The communication devices 12 and the control device 100 are communicably connected via a wired or wireless network 2.

An object 10 processes each of a plurality of tasks dispersed in a space. The tasks are described below. The object 10 may be, for example, a machine, such as an autonomously movable robot. The object 10 may be a person or a robot arm. The object 10 may be any object capable of processing the tasks dispersed in the space. In the following description, the object 10 is a robot. When the object 10 is a machine, such as a robot or a robot arm, the communication device 12 may be built into the object 10. Alternatively, when the object 10 is a person, the communication device 12 may be a communication terminal, such as a smart phone or a tablet terminal, which can be carried on a person.

The object 10 moves in the space in which the tasks are dispersed. The object 10 moves in the space, reaches a position of the task, and then processes the task. In other words, the object 10 can change its position in the space (move in the space). In other words, the object 10 can change its state. The “state” here is a physical position in the space. In other words, the object 10 is an object that can change its state in the space. In the present embodiment, one object 10 can process one task. In other words, a plurality of objects 10 does not have to process one task.

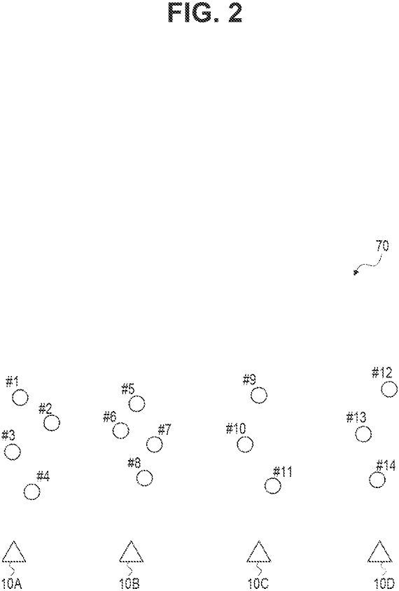

FIG. 2 is a diagram exemplifying tasks dispersed in the space according to the first embodiment. In the example of FIG. 2, tasks 1 to 14 are arranged in a space 70, which is an actual space. Further, in the space 70, there are four objects 10A to 10D. Each of the objects 10A to 10D processes one or more of the tasks 1 to 14. For example, the object 10A moves to a place in which the task 4 is arranged and processes the task 4. Further, for example, upon ending the processing of the task 4, the object 10A moves to a place in which the task 3 is arranged and processes the task 3. In the same manner, for example, the object 10B moves to a place in which the task 8 is arranged and processes the task 8.

A task is considered to be anything which is dispersed in the space and of which the processing can be ended by the object 10. For example, a task may be executing any work at each point in the space. For example, a task may be repairing a malfunctioning item (for example, a malfunctioning machine or a broken piece of furniture) arranged in the space. Further, for example, a task may be cleaning each point in the space. Further, for example, a task may be checking the number of customers (a crowded state of a store) in a store positioned in the space.

The communication device 12 is configured to transmit and receive a signal to and from the control device 100. The communication device 12 can have substantially the same function as a communication unit 106 described below. The communication device 12 receives, from the control device 100, an instruction for a corresponding object 10. The object 10 processes a task according to the instruction from the control device 100. Details are described below.

The control device 100 may be, for example, a computer, such as a server. The control device 100 may be realized by, for example, cloud computing. The control device 100 (the control system 1) controls the object 10 such that the object 10 processes the task. The control device 100 transmits the instruction for causing the object 10 to process the task to the communication device 12 corresponding to the object 10.

The control device 100 divides a plurality of tasks dispersed in the space into a plurality of groups each including one or more tasks, and assigns the respective groups to the respective objects 10. The control device 100 controls each of the objects 10 such that the object 10 processes a task of an assigned group. Then, when a processing status of the task satisfies a condition decided in advance, the control device 100 assigns a task of which processing has not been ended in another group to the object 10 that has ended the processing of all the tasks of the assigned group. Details are described below.

In the example of FIG. 2, for example, the control device 100 groups the tasks 1 to 4 into a group A. Further, for example, the control device 100 groups the tasks 5 to 8 into a group B. Further, for example, the control device 100 groups the tasks 9 to 11 into a group C. Further, for example, the control device 100 groups the tasks 12 to 14 into a group D. Then, the control device 100 assigns the group A to the object 10A. In the same manner, the control device 100 assigns the groups B to D to the objects 10B to 10D, respectively.

Further, the control device 100 controls the object 10A such that the object 10A processes the tasks 1 to 4 of the group A. The control device 100 controls the object 10B such that the object 10B processes the tasks 5 to 8 of the group B. The control device 100 controls the object 10C such that the object 10C processes the tasks 9 to 11 of the group C. The control device 100 controls the object 10D such that the object 10D processes tasks 12 to 14 of the group D.

Then, for example, the object 10A and the object 10B have ended the processing of all the assigned tasks. In this case, when the processing status of the task satisfies the condition decided in advance, the control device 100 assigns tasks of which the processing have not been ended in the other groups C, D to the objects 10A, 10B. As such, the objects 10A, 10B process the unprocessed tasks in the groups C, D.

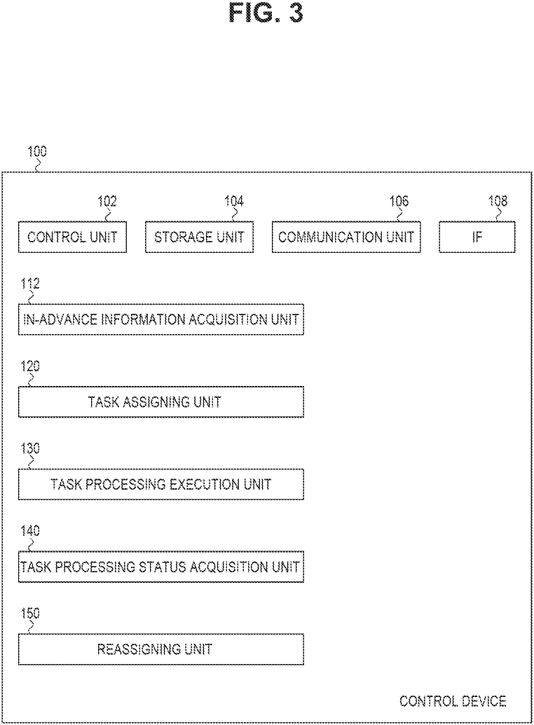

FIG. 3 is a diagram illustrating a configuration of the control device 100 according to the first embodiment. As illustrated in FIG. 3, as main hardware components, the control device 100 includes a control unit 102, a storage unit 104, a communication unit 106, and an interface (IF) unit 108. The control unit 102, the storage unit 104, the communication unit 106, and the IF unit 108 are connected to each other via a data bus or the like. The object 10, which is a machine, can also have the hardware configuration of the control device 100 illustrated in FIG. 3.

The control unit 102 is a processor, such as a central processing unit (CPU). The control unit 102 has a function as an arithmetic device that executes control processing, arithmetic processing, and the like. The control unit 102 may include a plurality of processors. The storage unit 104 may be, for example, a storage device, such as a memory or a hard disk. An example of the storage unit 104 includes a read-only memory (ROM) or a random access memory (RAM). The storage unit 104 has a function of storing, for example, a control program and an arithmetic program that are executed by the control unit 102. In other words, the storage unit 104 (the memory) stores one or more commands. Further, the storage unit 104 has a function of temporarily storing, for example, processing data. The storage unit 104 can include a database. Further, the storage unit 104 may include a plurality of memories.

The communication unit 106 executes processing necessary for communicating with another device, such as the communication device 12 (the object 10), via a network. The communication unit 106 can include, for example, a communication port, a router, and a firewall. An example of the IF unit 108 includes a user interface (UI). The IF unit 108 includes an input device, such as a keyboard, a touch panel, or a mouse, and an output device, such as a display or a speaker. The IF unit 108 may be configured to integrate the input device and the output device, such as a touch screen (a touch panel). The IF unit 108 receives a data input operation by a user (an operator) and outputs information to the user. The IF unit 108 may display, for example, a result of a task assigning.

The control device 100 according to the first embodiment includes, as components, an in-advance information acquisition unit 112, a task assigning unit 120, a task processing execution unit 130, a task processing status acquisition unit 140, and a reassigning unit 150. Each of the above-described components can be realized by, for example, executing a program under control of the control unit 102. More specifically, each component can be realized when the control unit 102 executes a program (a command) stored in the storage unit 104. Further, each component may be realized by recording a necessary program in an arbitrary non-volatile recording medium and installing it as necessary. Further, each component is not limited to being realized by software by a program, and may be realized by any combination of hardware, firmware, and software. Further, each component may be realized using a user-programmable integrated circuit, such as a field-programmable gate array (FPGA) or a microcomputer. In this case, a program composed of each component may be realized using the integrated circuit. This is also the same for other embodiments described below.

The in-advance information acquisition unit 112 acquires in-advance information. The in-advance information acquisition unit 112 stores the acquired in-advance information in the storage unit 104. The in-advance information is used when the task assigning unit 120 described below assigns tasks. Further, the in-advance information is used for acquiring an estimated required task time when the task assigning unit 120 described below assigns tasks. The estimated required task time is described below.

The in-advance information includes at least task information and object information. The task information can indicate, for example, a position of each of a plurality of tasks dispersed in the space. The object information can indicate the number of objects 10 and information on each of the objects 10. The object information can indicate a current position and performance of each object 10.

The performance of the object 10 can be any factor that can be used for acquiring an estimated required task time. For example, the performance of the object 10 includes a movement speed of the object 10 in the space. Further, for example, the performance of the object 10 includes a relative performance level of the object 10. In this case, for example, a performance level of the object 10A may be “high”, a performance level of the object 10B may be “intermediate”, and a performance level of the object 10C may be “low”. Further, for example, the performance of the object 10 can indicate a processing level of each task dispersed in the space. The processing level may be the processing time (an estimated task processing time) estimated when the object 10 processes each task. Further, the processing level may be a proficiency level (a degree of skillfulness/unskillfulness) of each object 10 for each task.

The estimated task processing time does not have to depend on the performance of the object 10. In other words, the estimated task processing time does not have to take into consideration differences in performances of the objects 10. In this case, the task information may indicate the estimated task processing time of each task without depending on the object 10. Further, in this case, the task information may indicate a difficulty level of processing.

The task assigning unit 120 divides a plurality of tasks dispersed in the space into the groups, each including one or more tasks, and assigns the respective groups to the respective plurality of objects 10. In other words, the task assigning unit 120 decides a task (a group) of which each object 10 is in charge. Here, the task assigning unit 120 may execute the assigning processing before the object 10 starts the processing of the task. In other words, after the object 10 starts the processing of the task, the task assigning unit 120 does not have to execute the assigning processing again. As such, once the object 10 starts the processing of the task, a composition of the group is not changed.

Further, the task assigning unit 120 may divide the tasks into groups according to an estimated time (an estimated required task time) required for each task. In this case, the task assigning unit 120 may execute task grouping (assigning the tasks) using a process such that the total of the estimated required task times in each group is not different between the groups as much as possible. In other words, the task assigning unit 120 may execute the task grouping (assigning the tasks) using a process such that the total of the estimated required task times in each group is not biased between the groups as much as possible. A specific example of the processing for assigning the tasks will be described below.

Here, the estimated required task time is a required time (a required task time) estimated for each task. The required task time corresponds to the total of a movement time of the object 10 to the task and a time (a task processing time) for the object 10 to process the task. Therefore, the estimated required task time corresponds to the total time of the movement time (an estimated movement time) that is estimated, and the task processing time (an estimated task processing time) that is estimated. Further, the estimated required task time of a next task after processing a certain task corresponds to the total time of the estimated movement time from a current position (the position of the processed task) to the next task and the estimated task processing time of the next task. In other words, the estimated required task time corresponds to the total of the estimated movement time from the position of the task (the task of a previous time) processed immediately prior and the estimated task processing time of the task to which the object 10 moves.

The estimated required task time can be acquired using the in-advance information. For example, the estimated movement time can be acquired from a distance from the current position of the object 10 to the position of the task and a movement speed of the object 10. Further, the estimated task processing time can be acquired from a performance of the object 10 or the like. Alternatively, when the time for processing the task does not depend on the performance of the object 10 or when differences in performances of the objects 10 are not considered, the estimated task processing time can be acquired from the task information. Further, when the estimated task processing time cannot be acquired, the estimated task processing times for all the tasks may be regarded as the same time.

The task processing execution unit 130 controls each of the objects 10 such that the object 10 processes the tasks of the assigned group. Specifically, the task processing execution unit 130 generates an instruction (an object instruction) indicating that each object 10 processes the tasks of the assigned group. Then, the task processing execution unit 130 transmits the object instruction corresponding to each object 10 to the communication device 12 corresponding to each object 10.

The object instruction includes an instruction (a movement instruction) indicating that each object 10 moves to the assigned task. The movement instruction can indicate an order in which the tasks included in the group assigned to the corresponding object 10 are processed, that is, a movement route of the object 10. The order in which the tasks are processed may be decided, for example, as follows. First, it is decided that the object 10 moves from its current position to the task having the shortest required task time (or the movement time). Next, from the task, it is decided that the object 10 moves to the task having the shortest the required task time (or the movement time) from among the unprocessed tasks. In the same manner, the next task to which the object 10 moves is decided. For example, in the example of FIG. 2, when the group A composed of the tasks 1 to 4 is assigned to the object 10A, the movement instruction can indicate that the object 10 first moves to the task 4, then moves to the task 3, then moves to the task 2, and then moves to the task 1.

Further, the object instruction includes an instruction (a task processing instruction) indicating that each object 10 processes the task of the assigned group. Further, the object instruction includes an instruction (a stand-by instruction) indicating that each object 10 stands by at a predetermined position (a state) after completing the processing of all the tasks of the assigned group. For example, the stand-by instruction may indicate that the object 10 stands by near a position of the task that has been last processed. Alternatively, the stand-by instruction may indicate that the object 10 stands by at an initial position.

The task processing status acquisition unit 140 acquires task processing status information indicating a task processing status. Specifically, the task processing status acquisition unit 140 acquires, as the task processing status information, for example, information on the task of which the processing has been ended by each object 10, information on the task that is currently being processed, information on the unprocessed task, and position information indicating the current position of each object 10. Then, the task processing status acquisition unit 140 stores the acquired task processing status information in the storage unit 104.

The reassigning unit 150 reassigns the unprocessed task. When the task processing status satisfies a condition (a trigger condition) decided in advance, the reassigning unit 150 assigns a task of which the processing has not been ended in another group to the object 10 that has completed the processing of all the tasks of the assigned group. In other words, when the task processing status satisfies the trigger condition, the reassigning unit 150 decides to reassign the task. Even when the reassigning is executed, the composition of the group decided by the task assigning unit 120 is not changed.

Here, in the first embodiment, the “the condition (the trigger condition) decided in advance” means that the number of objects 10 (task completion objects) that have completed the processing of all the tasks of the assigned groups is equal to or higher than a predetermined number. In other words, when the number of objects 10 that have completed the processing of all the tasks of the assigned groups is equal to or higher than the predetermined number, the reassigning unit 150 assigns the tasks of which the processing has not been ended in other groups to the objects 10 that have completed the processing of all the tasks. In other words, when the number of task completion objects is equal to or higher than the predetermined number, the reassigning unit 150 assigns the tasks (the unprocessed tasks) of which the processing has not been ended in the groups (the unprocessed groups) including the unprocessed tasks to the task completion objects.

The “predetermined number” can be decided from, for example, a ratio of the number of the task completion objects to the total number of objects 10. For example, the predetermined number may be 50% of the total number of objects 10. In this case, in the example of FIG. 2, since the total number of objects 10 is four, the “predetermined number” is two. Therefore, when two objects 10 have completed the processing of all the tasks of the assigned groups, task reassigning processing is executed. The predetermined number may be a number that does not have to depend on the total number of objects 10. For example, the predetermined number may be set to two without depending on the total number of objects 10. In other words, in the first embodiment, when the objects 10 have completed the processing of all the tasks of the assigned groups, the reassigning unit 150 executes the reassigning processing.

Further, when the unprocessed tasks are reassigned to the task completion objects, the reassigning unit 150 may execute the reassigning such that the times for ending the processing of all the tasks of the unprocessed groups are not biased between the unprocessed groups as much as possible. For example, when the unprocessed tasks are reassigned to the task completion objects, the reassigning unit 150 may execute the reassigning using a process such that the total of the estimated required task times of the unprocessed groups are not biased between the unprocessed groups as much as possible. Further, the reassigning unit 150 may execute the reassigning such that the predetermined number of task completion objects assists different unprocessed groups. In other words, the reassigning unit 150 rearranges the predetermined number of task completion objects to different unprocessed groups. Details are described below.

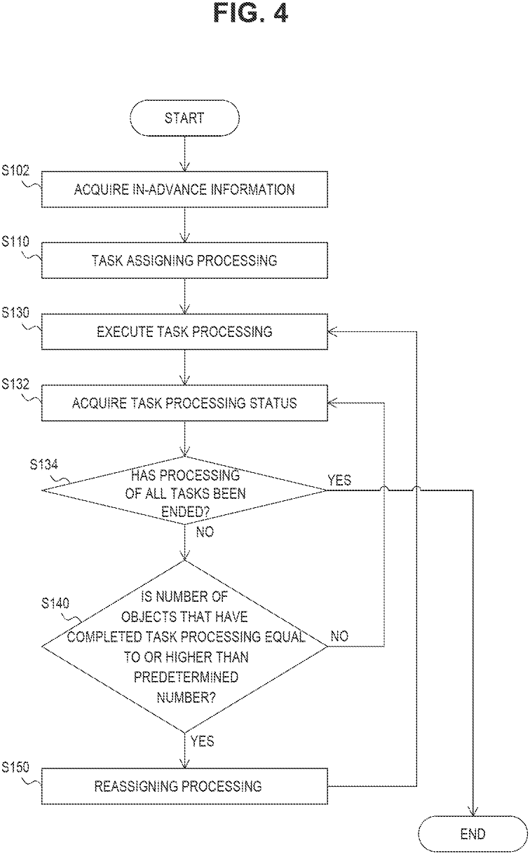

FIG. 4 is a flowchart illustrating a control method executed by the control system 1 according to the first embodiment. The in-advance information acquisition unit 112 acquires the in-advance information as described above (step S102). The task assigning unit 120 executes the task assigning processing using the in-advance information (step S110). Specifically, the task assigning unit 120 acquires the estimated required task time from the in-advance information. Then, the task assigning unit 120 assigns each task to each object 10 according to the estimated required task time and groups the tasks into a group for each object 10. Various methods can be employed for the method (a grouping method) of assigning the tasks. For example, there is a method of assigning (grouping) the tasks by applying a greedy algorithm. Hereinbelow, description is made using a flowchart.

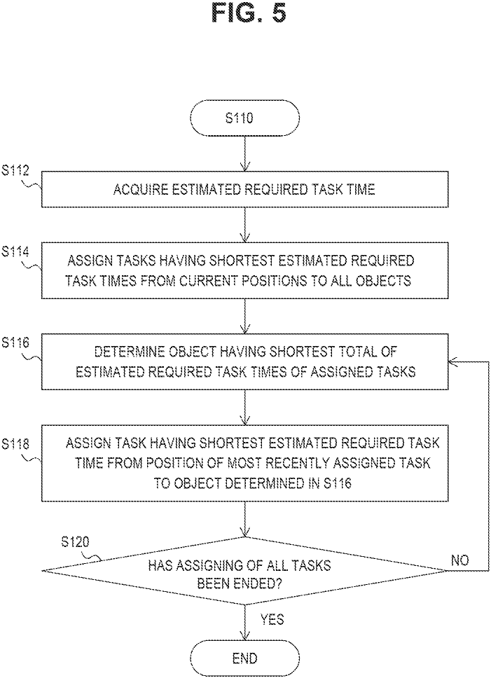

FIG. 5 is a flowchart illustrating an example of the task assigning processing of the task assigning unit 120 according to the first embodiment. The task assigning unit 120 acquires the estimated required task time (step S112). Specifically, the task assigning unit 120 acquires the estimated required task time of each task for each object 10 using the in-advance information. Here, as described above, the estimated required task time is the total of the estimated movement time from the current position of each object 10 to each task and the estimated task processing time of the task. For example, in the example of FIG. 2, the estimated required task time of the task 4 for the object 10A is the total of the estimated movement time from the current position of the object 10A to the task 4, and the estimated task processing time estimated to be required for the object 10 to process the task 4.

As described above, the estimated movement time can be acquired from the distance from the current position of the object 10 to the position of the task and the movement speed of the object 10. Further, the estimated task processing time can be acquired from, for example, the performance of the object 10. Alternatively, when the task processing time does not depend on the performance of the object 10 or when the differences in the performances of the objects 10 are not considered, the estimated task processing time can be acquired from the task information. In this case, the task information may indicate the estimated task processing time of each task. Further, when the estimated task processing time cannot be acquired, the task assigning unit 120 may acquire the estimated task processing times by regarding the estimated task processing times for all the tasks as the same time.

The task assigning unit 120 assigns the tasks having the shortest estimated required task times from the current positions to all the objects 10 (step S114). For example, in the example of FIG. 2, the task having the shortest estimated required task time from the current position for the object 10A is the task 4. Further, the task having the shortest estimated required task time from the current position for the object 10B is the task 8. Further, the task having the shortest estimated required task time from the current position for the object 10C is the task 11. Further, the task having the shortest estimated required task time from the current position for the object 10D is the task 14. In this case, the task assigning unit 120 assigns the task 4 to the object 10A. In the same manner, the task assigning unit 120 assigns the task 8 to the object 10B, the task 11 to the object 10C, and the task 14 to the object 10D.

At this time, the task assigning unit 120 assigns different tasks to each object 10. In other words, when two objects 10 have the same task having the shortest estimated required task time, the task assigning unit 120 may assign the task to any one of the objects 10A (for example, the object 10 of which the current position is closer to the task). Then, the task assigning unit 120 may assign the task having a second shortest estimated required task time to the other object 10.

In the process of S114, the task assigning unit 120 assigns the task having the shortest estimated required task time from the current position to each object 10, but such a configuration is not limited thereto. The task assigning unit 120 may assign the task having the shortest estimated movement time from the current position to each object 10.

Next, the task assigning unit 120 determines the object 10 having the shortest total estimated required task times of the assigned tasks (step S116). Specifically, the task assigning unit 120 calculates the total time of the estimated required task times of the assigned tasks for each object 10. Then, the task assigning unit 120 determines the object 10 having the shortest total time of the estimated required task times.

The task assigning unit 120 assigns the task having the shortest estimated required task time from the position of the most recently assigned task to the object 10 determined in S116 (step S118). As such, since the next task is assigned to the object 10 having the shortest total time of the estimated required task times, it is possible to restrict the total time of the estimated required task times from being biased between the objects 10. Further, since the next task that is assigned is the task having the shortest estimated required task time, even when the task is assigned, it is possible to restrict the total time of the estimated required task times for the object 10 from suddenly being increased. Therefore, it is possible to restrict the total time of the estimated required task times from being biased between the objects 10.

In the process of S118, the task assigning unit 120 assigns the task having the shortest estimated required task time from the position of the most recently assigned task to the object 10 having the shortest total time of the estimated required task times of the assigned tasks. However, the task assigning unit 120 may assign the task having the shortest estimated required movement time from the position of the most recently assigned task to the object 10 having the shortest total of the estimated required task times of the assigned tasks.

The task assigning unit 120 determines whether the assigning of all the tasks has been ended (step S120). When the assigning of all the tasks has been ended (YES in S120), all the tasks are grouped for each object 10. Therefore, the task assigning unit 120 ends the process. On the other hand, when the assigning of all the tasks has not been ended (NO in S120), there are still tasks that have not been grouped. Therefore, a processing flow returns to S116, and the processes of S116 to S120 are repeated.

In the above-described example of FIG. 2, in the process of S114, the tasks 4, 8, 11, 14 are assigned to the objects 10A, 10B, 10C, 10D, respectively. At this time, the total time of the estimated required task time (the estimated required task time of the task 4) for the object 10A is 1.0 hour. Further, the total time of the estimated required task time (the estimated required task time of the task 8) for the object 10B is 2.0 hours. Further, the total time of the estimated required task time (the estimated required task time of the task 11) for the object 10C is 3.0 hours. Further, the total time of the estimated required task time (the estimated required task time of the task 14) for the object 10D is 4.0 hours. In this case, in the process of S116, the task assigning unit 120 determines that the object 10A is the object 10 having the shortest total time of the estimated required task times. Therefore, the task assigning unit 120 assigns the task having the shortest estimated required task time to the object 10A (S118).

Here, the task 3 is assigned to the object 10A. Then, the estimated required task time (the total time of the estimated movement time from the task 4 to the task 3 and the estimated task processing time of the task 3) is 0.5 hours. In this case, the total time (the total time of the estimated required task times of the task 4 and the task 3) of the estimated required task times for the object 10A is 1.5 hours. Therefore, in the next process of S116, the task assigning unit 120 determines again that the object 10A is the object 10 having the shortest total time of the estimated required task times. Therefore, the task assigning unit 120 assigns the task having the shortest estimated required task time to the object 10A (S118).

Here, the task 2 is assigned to the object 10A. Then, the estimated required task time (the total time of the estimated movement time from the task 3 to the task 2 and the estimated task processing time of the task 2) is 2.0 hours. In this case, the total time of the estimated required task times (the total time of the estimated required task times of the tasks 4, 3, 2) for the object 10A is 3.5 hours. Therefore, in the next process of S116, the task assigning unit 120 determines that the object 10B is the object 10 having the shortest total time of the estimated required task times. Therefore, the task assigning unit 120 assigns the task having the shortest estimated required task times to the object 10B (S118).

Here, the task 7 is assigned to the object 10B. Then, the estimated required task time (the total time of the estimated movement time from the task 8 to the task 7 and the estimated task processing time of the task 7) is 2.0 hours. In this case, the total time of the estimated required task times (the total time of the estimated required task times of the tasks 8, the task 7) for the object 10B is 4.0 hours. Therefore, in the next process of S116, the task assigning unit 120 determines that the object 10C is the object 10 having the shortest total time of the estimated required task times. Therefore, the task assigning unit 120 assigns the task having the shortest estimated required task time to the object 10C (S118). Thereafter, by executing the same processes, the tasks 1 to 14 are assigned to the objects 10A to 10D.

As above, for example, the tasks 1 to 4 are assigned to the object 10A. In other words, the tasks 1 to 4 are grouped into the group A corresponding to the object 10A. Further, the tasks 5 to 8 are assigned to the object 10B. In other words, the tasks 5 to 8 are grouped into the group B corresponding to the object 10B. Further, the tasks 9 to 11 are assigned to the object 10C. In other words, the tasks 9 to 11 are grouped into the group C corresponding to the object 10C. Further, the tasks 12 to 14 are assigned to the object 10D. In other words, the tasks 12 to 14 are grouped into the group D corresponding to the object 10D.

The description returns to the description of FIG. 4. As described above, the task processing execution unit 130 controls each of the objects 10 such that the object 10 processes the tasks of the assigned group (step S130). Specifically, the task processing execution unit 130 transmits the object instruction corresponding to each object 10 to the communication device 12 corresponding to each object 10. As such, each object 10 starts the processing of the tasks of the assigned group.

As described above, the task processing status acquisition unit 140 acquires the task processing status information (step S132). Using the task processing status information, the reassigning unit 150 determines whether the processing of all the tasks has been ended (step S134). When the processing of all the tasks has been ended (YES in S134), the processing flow ends.

On the other hand, when the processing of all the tasks has not been ended (NO in S134), the reassigning unit 150 determines whether the number of objects (the task completion objects) 10 that have completed the processing of all the tasks of which they are in charge is equal to or higher than a predetermined number (step S140). Specifically, using the task processing status information, the reassigning unit 150 determines the task completion objects. More specifically, using the task processing status information, the reassigning unit 150 determines the task completion objects by determining whether the processing of all the assigned tasks has been completed for each object 10. Then, the reassigning unit 150 determines whether the number of the determined task completion objects is equal to or higher than the predetermined number. For example, as described above, the predetermined number may be 50% of the total number of objects 10.

When the number of task completion objects is not equal to or higher than the predetermined number (NO in S140), the processing flow returns to S132. Then, the processes of S132 to S140 are repeated. On the other hand, when the number of task completion objects is equal to or higher than the predetermined number (YES in S140), the above-described trigger condition for the reassigning is satisfied. In this case, the reassigning unit 150 executes the reassigning processing (step S150).

Specifically, the reassigning unit 150 assigns the unprocessed groups to the task completion objects, and assigns the tasks (unprocessed tasks) that are unprocessed in the unprocessed groups. When the unprocessed tasks are reassigned to the task completion objects, the reassigning unit 150 may execute the reassigning such that times for ending the processing of all the unprocessed tasks of the unprocessed groups are not biased between the unprocessed groups as much as possible. For example, the reassigning unit 150 may assign the unprocessed groups to the task completion objects such that the number of objects processing the tasks in the unprocessed groups is not biased between the unprocessed groups as much as possible.

For example, the reassigning unit 150 rearranges each task completion object to the unprocessed group including the unprocessed task having the shortest estimated movement time (or the estimated required task time) from the position of the task completion object. In other words, the reassigning unit 150 assigns the unprocessed task having the shortest estimated movement time to each task completion object and assigns the unprocessed group including the unprocessed task. At this time, the reassigning unit 150 may rearrange each task completion object to a different unprocessed group.

Here, when the task completion objects are reassigned to the same unprocessed group including the unprocessed task having the shortest estimated movement time, the reassigning unit 150 may rearrange only one of the task completion objects to the unprocessed group. Then, the reassigning unit 150 may rearrange the other task completion objects to different unprocessed groups.

For example, the reassigning unit 150 may rearrange, to an unprocessed group X, the task completion object having the shortest estimated movement time to the unprocessed task belonging to the unprocessed group X. Then, the reassigning unit 150 may reassign, to another task completion object, the unprocessed task having the shortest estimated movement time in an unprocessed group Y other than the above unprocessed group. As such, each task completion object can be rearranged to a different unprocessed group. Further, by rearranging the task completion objects in this manner, the processing of the unprocessed task in the unprocessed group X can be early started.

Alternatively, the reassigning unit 150 may rearrange, to another unprocessed group Y, the task completion object having the shortest estimated movement time to the unprocessed task included in another unprocessed group Y other than the above unprocessed group X from among the task completion objects. Then, the reassigning unit 150 may rearrange, to the unprocessed group X, the task completion object having the longest estimated movement time to the unprocessed task included in another unprocessed group Y other than the above unprocessed group X inform among the task completion objects. As such, each task completion object can be rearranged to a different unprocessed group. Further, by rearranging the task completion objects in this manner, it is possible to restrict the movement time of each task completion object from being biased.

For example, in the example of FIG. 2, the tasks 1 to 4, the tasks 5 to 8, the tasks 9 to 11, and the tasks 12 to 14 are grouped into the groups A, B, C, D, respectively. Then, the object 10C completes the processing of all the tasks of the group C and stands by at the position of the task 9, and the object 10D completes the processing of all the tasks of the group D and stands by at the position of the task 12. At this time, the tasks 1, 2 of the group A are unprocessed, and the tasks 5, 6 of the group B are unprocessed. In this case, the unprocessed task having the shortest estimated movement time from the objects 10C, 10D, which are the task completion objects, is the task 5 included in the group B. In such a state, the objects 10C, 10D are rearranged to the same group B. On the other hand, the estimated movement time from the position of the object 10C to the unprocessed task 2 of the group A is shorter than the estimated movement time from the position of the object 10D to the unprocessed task 2 of the group A. Therefore, the reassigning unit 150 may rearrange the object 10C to the group A and rearrange the object 10D to the group B.

However, in the unprocessed group, when the object 10 starts the processing of a last task or when the object 10 starts the movement toward the last task, the task completion object does not have to be rearranged to the unprocessed group. This is because rearranging the task completion object to such an unprocessed group can be wasteful. In other words, even when the task completion object is rearranged to such an unprocessed group, when the task completion object reaches the unprocessed group, it is highly possible that the object 10 that has originally been arranged to the unprocessed group is already processing the last task. In this case, there are no tasks for the task completion object to process in the unprocessed group to which it has been rearranged. Therefore, rearranging the task completion object to such an unprocessed group can be wasteful.

Therefore, the reassigning unit 150 rearranges the task completion objects to the unprocessed groups excluding such unprocessed groups. When the number of unprocessed groups to which the task completion objects are to be rearranged is smaller than the number of task completion objects, the reassigning unit 150 may rearrange two or more task completion objects to one unprocessed group. The reassigning unit 150 executes the reassigning such that the unprocessed group to which two or more task completion objects are to be rearranged includes the number of unprocessed tasks equal to or higher than the number of task completion objects.

When the reassigning processing is executed, the processing flow returns to S130. Then, the task processing execution unit 130 controls the task completion object such that the task completion object processes the task of the reassigned group (S130).

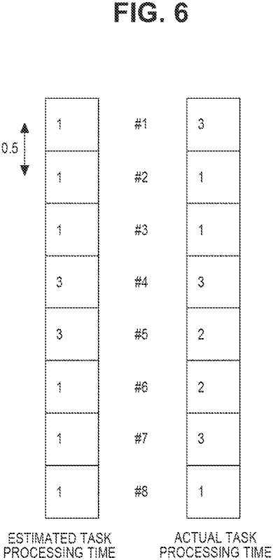

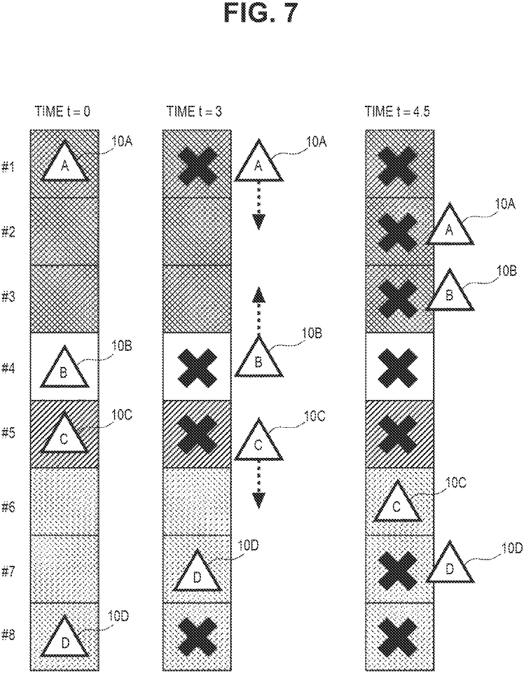

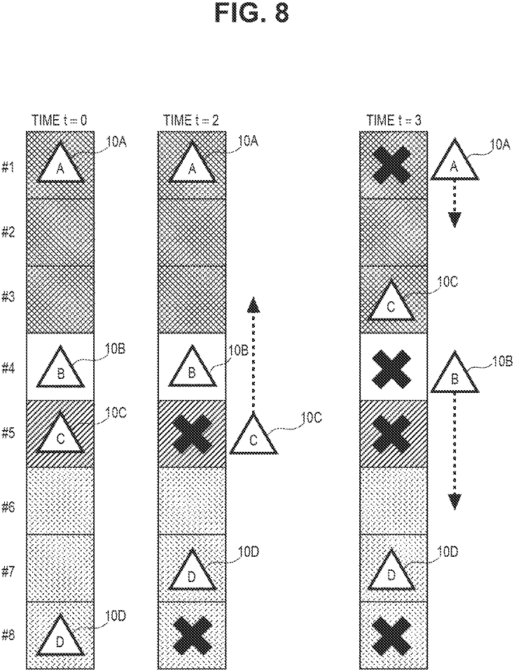

FIGS. 6 to 8 are diagrams for describing a first specific example. FIG. 6 is a diagram illustrating arranging of the tasks according to the first specific example. FIG. 7 is a diagram for describing a case where the method according to the first embodiment is used in the first specific example. FIG. 8 is a diagram for describing a case where a method according to a comparative example is used in the first specific example.

As illustrated in FIG. 6, in the first specific example, the tasks 1 to 8 are arranged in a straight line. Then, the four objects 10A to 10D process the tasks. In the first specific example, each task is equally spaced, and the movement time between adjacent tasks is T = 0.5. The task may be, for example, a cleaning work on each floor of an eight-story building. Alternatively, the task may be, for example, repairing each of eight malfunctioning machines arranged in a line.

Further, the estimated task processing time of each task is known in advance, as illustrated in FIG. 6. In other words, the estimated task processing time of the task 1 is T = 1. The estimated task processing time of the task 2 is T = 1. The estimated task processing time of the task 3 is T = 1. The estimated task processing time of the task 4 is T = 3. The estimated task processing time of the task 5 is T = 3. The estimated task processing time of the task 6 is T = 1. The estimated task processing time of the task 7 is T = 1. The estimated task processing time of the task 8 is T = 1.

As illustrated in FIG. 6, the actual task processing times are as follows. These actual task processing times are first known after the objects 10 process the task. The actual task processing time of the task 1 is T = 3. The actual task processing time of the task 2 is T = 1. The actual task processing time of the task 3 is T = 1. The actual task processing time of the task 4 is T = 3. The actual task processing time of the task 5 is T = 2. The actual task processing time of the task 6 is T = 2. The actual task processing time of the task 7 is T = 3. The actual task processing time of the task 8 is T = 1.

Further, in the first specific example, the trigger condition for executing the reassigning according to the first embodiment is “50% of the total number of objects 10 that have completed the processing of all the assigned tasks.” Since the number of objects 10 is four, when two objects 10 have completed the processing of all the tasks assigned thereto, these two objects 10 are rearranged to the groups associated with the other two objects 10. In other words, when two objects 10 have completed the processing of all the tasks assigned thereto, these two objects 10 assist the other two objects 10. When another object 10 has completed the processing of all the tasks and there is the unprocessed task, the object 10 may be rearranged.

Further, as illustrated in FIG. 7, in the initial state (time t = 0), the object 10A is arranged to the position of the task 1. Further, the object 10B is arranged to the position of the task 4. Further, the object 10C is arranged to the position of the task 5. Further, the object 10D is arranged to the position of the task 8.

The task assigning unit 120 assigns each task to each object 10 as follows from the movement time and the estimated task processing time. The task assigning unit 120 assigns the tasks 1, 2, 3 to the object 10A. Therefore, the tasks 1, 2, 3 belong to the group A. Further, the task assigning unit 120 assigns the task 4 to the object 10B. Therefore, the task 4 belongs to the group B. Further, the task assigning unit 120 assigns the task 5 to the object 10C. Therefore, the task 5 belongs to the group C. The task assigning unit 120 assigns the tasks 6, 7, 8 to the object 10D. Therefore, the tasks 6, 7, 8 belong to the group D.

At time t = 3, the object 10A ends the processing of the task 1. Thereafter, the object 10A moves to the position of the next task 2 and processes the task 2. In other words, at time t = 3, the tasks 2, 3 among the tasks of the group A are unprocessed tasks, and the processing of the tasks 2, 3 has not yet started.

Further, at time t = 3, the object 10D is processing the task 7. In other words, the object 10D ends the processing of the task 8 at time t = 1. Then, the object 10D reaches the position of the next task 7 at time t = 1.5 and starts the processing of the task 7. Therefore, by time t = 3, time T = 1.5 elapses since the object 10D has started the processing of the task 7. At time t = 3, among the tasks of the group D, the tasks 6, 7 are unprocessed tasks, and the processing of the task 7 has been started but the processing of the task 6 has not yet started.

On the other hand, at time t = 3, the object 10C has already ended the processing of the task 5. In other words, at time t = 2, the object 10C ends the processing of the task 5. Therefore, the object 10C completes the processing of all the tasks assigned thereto. However, since the other objects 10 have not completed the processing of all the tasks assigned thereto, the object 10C stands by.

Then, at time t = 3, the object 10B ends the processing of the task 4. Therefore, the object 10B completes the processing of all the tasks assigned thereto. As such, since two objects 10B, 10C have completed the processing of all the tasks assigned thereto, the reassigning unit 150 executes the reassigning. Specifically, the reassigning unit 150 assigns the tasks of the groups A, D, which are unprocessed groups, to the objects 10B, 10C. In other words, the reassigning unit 150 assigns the tasks assigned to the objects 10A, 10D to the objects 10B, 10C.

At time = 3, the reassigning unit 150 assigns, to the object 10B, the task 3, which is the task having the shortest (that is, the closest) movement time from among the unprocessed tasks of the unprocessed groups, from the position of the object 10B (the position of the task 4). As such, the object 10B is rearranged to the group A and assists the object 10A. Thereafter, the object 10B moves toward the position of the task 3. Then, at time t = 3.5, the object 10B reaches the position of the task 3 and starts the processing of the task 3.

Further, at time = 3, the reassigning unit 150 assigns, to the object 10C, the task 6, which is the task having the shortest (that is, the closest) movement time from among the unprocessed tasks of the unprocessed groups, from the position of the object 10C (the position of the task 5). As such, the object 10C is rearranged to the group D and assists the object 10D. Thereafter, the object 10C moves toward the position of the task 6. Then, at time t = 3.5, the object 10C reaches the position of the task 6 and starts the processing of the task 6.

At time t = 4.5, the object 10A ends the processing of the task 2. In other words, at time t = 3.5, the object 10A reaches the position of the task 2 and starts the processing of the task 2. Then, at time t = 4.5, at which point time T = 1 elapses since then, the object 10A ends the processing of the task 2.

Further, at time t = 4.5, the object 10B ends the processing of the task 3. In other words, as described above, at time t = 3.5, the object 10B reaches the position of the task 3 and starts the processing of the task 3. Then, at time t = 4.5, at which point time T = 1 elapses since then, the object 10B ends the processing of the task 3.

Further, at time t = 4.5, the object 10C is processing the task 6. In other words, as described above, at time t = 3.5, the object 10C reaches the position of the task 6 and starts the processing of the task 6. Then, at time t = 4.5, time T = 1 elapses since the object 10C has started the processing of the task 6.

Further, at time t = 4.5, the object 10D ends the processing of the task 7. In other words, as described above, at time t = 1.5, the object 10D reaches the position of the task 7 and starts the processing of the task 7. Therefore, at time t = 4.5, at which point T = 3 elapses since then, the object 10D ends the processing of the task 7.

Then, at time t = 5.5 at which point time T = 2 elapses since time t = 3.5, the object 10C ends the processing of the task 6. As such, at time t = 5.5, the processing of all the tasks 1 to 8 is ended. Further, all the movements of each object 10 are “one-time movements to the position of the adjacent task”. In other words, the movement time (the movement distance) of each object 10 is restricted to the minimum.

On the other hand, a condition for executing the reassigning according to the comparative example illustrated in FIG. 8 is “when the object 10 has completed the processing of all the tasks of which it is in charge, the object 10 is immediately rearranged to the group estimated to require the longest time for processing the tasks.” The initial state (time t = 0) and assigning the tasks are the same as in the case of FIG. 7.

At time t = 2, the object 10A is processing the task 1. Further, at time t = 2, the object 10B is processing the task 4. Further, at time t = 2, the object 10D is processing the task 7. In other words, at time t = 1, the object 10D ends the processing of the task 8. Then, the object 10D reaches the position of the next task 7 at time t = 1.5 and starts the processing of the task 7. Therefore, at time t = 2, time T = 0.5 elapses since the object 10D has started the processing of the task 7. As such, the objects 10A, 10B, 10D have not yet completed the processing of all the tasks of which they are in charge.

On the other hand, at time t = 2, the object 10C ends the processing of the task 5. Therefore, the object 10C completes the processing of all the tasks assigned thereto. Therefore, at time t = 2, the object 10C is rearranged to another group. Here, the total of the estimated task processing times of remaining tasks in the group A in which the processing of the tasks has not been completed is T = 2. Further, the total estimated task processing times of remaining tasks in the group A in which the processing of the tasks has not been completed is T = 1.5. There is no unprocessed task of which the processing has not started in the group B in which the processing of the tasks has not been completed. Therefore, the object 10C is rearranged to the group A having the highest total remaining estimated task processing times. From among the groups A, B, D, which are the unprocessed groups, since the unprocessed group having the largest number of unprocessed tasks of which the processing has not started is the group A, the object 10C may be rearranged to the group A. Therefore, the object 10C moves toward the task 3 of the group A, which is closest to the current position of the object 10C.

At time t = 3, the object 10A ends the processing of the task 1. Then, the object 10A moves toward the next task 2. Further, at time t = 3, the object 10C rearranged to the group A starts the processing of the task 3. In other words, the object 10C moves a distance by two tasks from the task 5 and reaches the task 3. Therefore, at time t = 3, at which point time T=1 (= 0.5 × 2) elapses since time t = 2, the object 10C reaches the task 3. Therefore, at time t = 3, the object 10C starts the processing of the task 3. Further, at time t = 3, the object 10D is processing the task 7. In other words, by time t = 3, time T = 1.5 elapses since the object 10D has started the processing of the task 7.

On the other hand, at time t = 3, the object 10B ends the processing of the task 4. Therefore, the object 10B completes the processing of all the tasks assigned thereto. Therefore, at time t = 3, the object 10B is rearranged to another group. Here, from among the groups A, D, which are unprocessed groups, the object 10A is moving toward the final task 2 of the group A. Therefore, the object 10B is not rearranged to the group A. Therefore, the object 10B is rearranged to the group D. Therefore, the object 10B moves toward the task 6, which is the closest unprocessed task in the group D.

Thereafter, at time t = 4.5, the object 10A ends the processing of the task 2. Further, at time t = 4, the object 10C ends the processing of the task 3. Further, at time t = 4 at which point time T = 1 (= 0.5 × 2) elapses since time t = 3, the object 10B reaches the task 6. Therefore, at time t = 4, the object 10B starts the processing of the task 6. Then, at time t = 6, the object 10B ends the processing of the task 6. Further, at time t = 4.5, the object 10D ends the processing of the task 7.

As described above, in the comparative example, at time t = 6, the processing of all the tasks 1 to 8 is ended. Therefore, the time until all the tasks are ended in the comparative example is longer than the case in the first embodiment. Further, in the comparative example, the movements of the objects 10B, 10C are “one-time movements to a position distanced by two tasks.” Therefore, the movement time (the movement distance) of the object 10 in the comparative example is longer than that in the method according to the first embodiment.

As illustrated in FIG. 7, by not executing the reassigning processing until time t = 3 when both the objects 10B, 10C complete the processing of the tasks of which they are in charge, the objects 10B, 10C can execute the tasks close thereto respectively. However, whether it is good not to execute the reassigning processing until time t = 3 it not known until time t = 3. Therefore, as illustrated in FIG. 8, when the reassigning processing is executed immediately after the object 10 ends the processing of the task of which it is in charge, the object 10 may process a relatively distant task. Then the entire processing time may be increased and the movement time and the movement distance may be increased.

Conversely, the control system 1 according to the first embodiment is configured to assign the task of which the processing has not been ended in another group to the object 10 that has completed the processing of all the assigned tasks of the assigned group. As such, it is highly possible that the task completion object can be reassigned a task close thereto. Therefore, the control system 1 according to the first embodiment can efficiently process all the tasks.

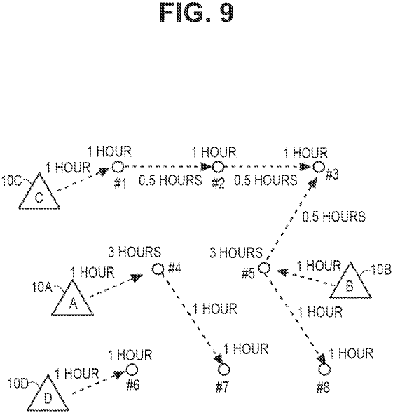

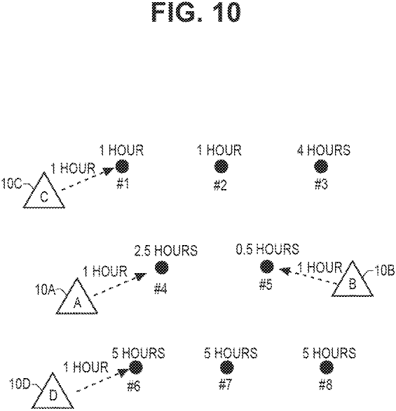

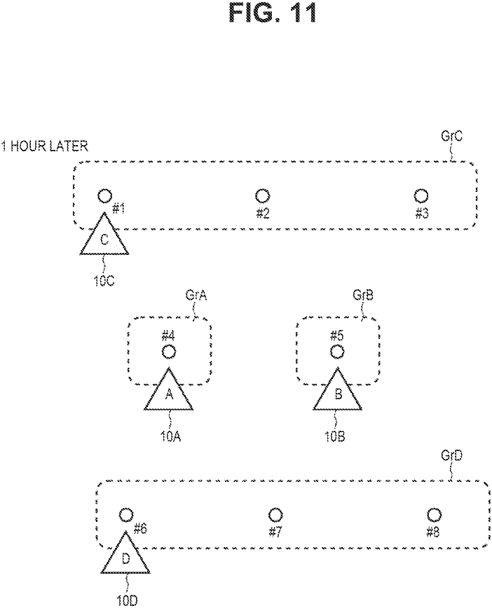

FIGS. 9 to 15 are diagrams for describing a second specific example. FIGS. 9 and 10 are diagrams illustrating arranging of the tasks according to the second specific example. FIGS. 11 to 15 are diagrams for describing a case where the method according to the first embodiment is used in the second specific example.

As illustrated in FIG. 9, in the second specific example, the tasks 1 to 8 are arranged on a plane. Then, the four objects 10A to 10D process the tasks. The tasks may be, for example, repairing each of eight malfunctioning machines arranged on the plane. Alternatively, the task may be, for example, cleaning eight places arranged on the plane.

As illustrated in FIG. 9, the movement time between the tasks is shown near arrows connecting the tasks. As illustrated in FIG. 9, in the second specific example, the movement times between tasks are different. The movement time from the position of the task 1 to the position of the task 2 is 0.5 hours, and the movement time from the position of the task 2 to the position of the task 3 is 0.5 hours. Further, the movement time from the position of the task 4 to the position of the task 7 is 1 hour, and the movement time from the position of the task 5 to the position of the task 3 is 0.5 hours, and the movement time from the position of the task 5 to the position of the task 8 is 1 hour. The movement time between tasks without arrows is 1.5 hours or longer.

Further, in the second specific example, the initial position of each object 10 is not near the task. Therefore, it is necessary to consider the movement time from the initial position of each object 10 to the task closest thereto. The movement time from the initial position of the object 10A to the position of the task 4 is 1 hour. The movement time from the initial position of the object 10B to the position of the task 5 is 1 hour. The movement time from the initial position of the object 10C to the position of the task 1 is 1 hour. The movement time from the initial position of the object 10D to the position of the task 6 is 1 hour.

Further, the estimated task processing time of each task is known in advance, as illustrated in FIG. 9. In other words, the estimated task processing time of the task 1 is 1 hour. The estimated task processing time of the task 2 is 1 hour. The estimated task processing time of the task 3 is 1 hour. The estimated task processing time of the task 4 is 3 hours. The estimated task processing time of the task 5 is 3 hours. The estimated task processing time of the task 6 is 1 hour. The estimated task processing time of the task 7 is 1 hour. The estimated task processing time of the task 8 is 1 hour.

FIG. 10 illustrates the actual task processing time of each task. These actual task processing times are first known after the objects 10 process the task. The actual task processing time of the task 1 is 1 hour. The actual task processing time of the task 2 is 1 hour. The actual task processing time of the task 3 is 4 hours. The actual task processing time of the task 4 is 2.5 hours. The actual task processing time of the task 5 is 0.5 hours. The actual task processing time of the task 6 is 5 hours. The actual task processing time of the task 7 is 5 hours. The actual task processing time of the task 8 is 5 hours.

Further, in the second specific example, the trigger condition for executing the reassigning according to the first embodiment is “50% of the total number of objects 10 have completed the processing of all the assigned tasks.” Since the number of objects 10 is four, when two objects 10 have completed the processing of all the tasks assigned thereto, these two objects 10 are rearranged to the groups associated with the other two objects 10. In other words, when two objects 10 have completed the processing of all the tasks assigned thereto, these two objects 10 assist the other two objects 10. When another object 10 has completed the processing of all the tasks and there is the unprocessed task, the rearranging may be executed.

The task assigning unit 120 assigns each task to each object 10 as follows from the movement time and the estimated task processing time. The task assigning unit 120 assigns the tasks 1, 2, 3 to the object 10C. Therefore, the tasks 1, 2, 3 belong to a group GrC. Further, the task assigning unit 120 assigns the task 4 to the object 10A. Therefore, the task 4 belongs to a group GrA. Further, the task assigning unit 120 assigns the task 5 to the object 10B. Therefore, the task 5 belongs to a group GrB. The task assigning unit 120 assigns the tasks 6, 7, 8 to the object 10D. Therefore, the tasks 6, 7, 8 belong to a group GrD.

FIG. 11 illustrates the state of 1 hour later in the second specific example. Each of the objects 10A to 10D moves to the position of the task to be processed first and starts the processing of the task. Specifically, the object 10A starts the processing of the task 4. The object 10B starts the processing of the task 5. The object 10C starts the processing of the task 1. The object 10D starts the processing of the task 6.

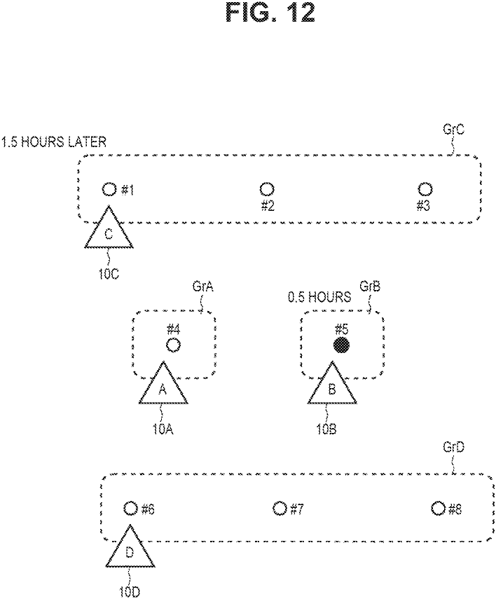

FIG. 12 illustrates the state of 1.5 hours later in the second specific example. The object 10B ends the processing of the task 5 much earlier than the estimated task processing time. As such, the object 10B completes the processing of all the tasks of the group GrB. At this point, since only the object 10B has completed the task of its own group, the trigger condition is not satisfied. Therefore, the object 10B stands by without assisting other groups. Further, the object 10A is processing the task 4. The object 10C is processing the task 1. The object 10D is processing the task 6.

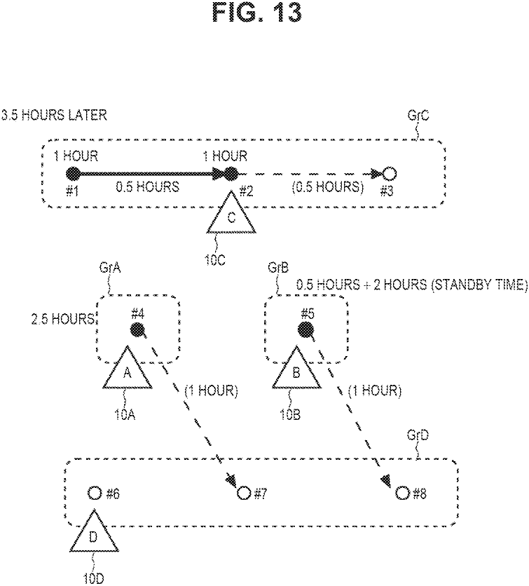

FIG. 13 is illustrating the state of 3.5 hours later in the second specific example. The object 10D is processing the task 6. The object 10C has ended the processing of the tasks 1, 2 and is starting the movement to the final task 3. In other words, 2 hours later, the object 10C ends the processing of the task 1, then, 2.5 hours later, moves to the position of the next task 2, and, 3.5 hours later, ends the processing of the task 2. Then, the object 10C starts the movement to the final task 3.

Further, the object 10B has completed the processing of the task of the group GrB has been standing by for 2 hours. Further, the object 10A ends the processing of the task 4. As such, the object 10A completes the processing of all the tasks of the group GrA. As such, since the number of task completion objects is two, the trigger condition is satisfied. Therefore, the reassigning unit 150 executes the reassigning processing. As such, the objects 10A, 10B are rearranged to the other groups. Specifically, the reassigning unit 150 assigns the tasks of the groups GrC, GrD, which are unprocessed groups, to the objects 10A, 10B. In other words, the reassigning unit 150 assigns the tasks assigned to the objects 10C, 10D to the objects 10A, 10B. At this time, the reassigning unit 150 rearranges the objects 10A, 10B in consideration of the movement time to the task and the estimated task processing time.

Here, at this point, as described above, the object 10C has ended the processing of the tasks 1, 2, and is starting the movement to the final task 3. Therefore, even when the task completion object is rearranged to the group GrC, it is highly possible that there will be no tasks to be processed by the task completion object, so the rearranging may be wasted. Therefore, the reassigning unit 150 decides not to rearrange the task completion object to the group GrC. Therefore, the reassigning unit 150 decides to rearrange the objects 10A, 10B to the group GrD.

Then, the reassigning unit 150 decides to rearrange the object 10A to the task 7 having the shortest movement time (that is, the closest) from the position of the object 10A from among the unprocessed tasks of the group GrD. In other words, the reassigning unit 150 assigns the task 7 to the object 10A. Further, the reassigning unit 150 decides to rearrange the object 10B to the task 8 having the shortest movement time (that is, the closest) from the position of the object 10B from among the unprocessed tasks of the group GrD. In other words, the reassigning unit 150 assigns the task 8 to the object 10B. As such, the object 10A starts the movement toward the task 7. Further, the object 10B starts the movement toward the task 8.

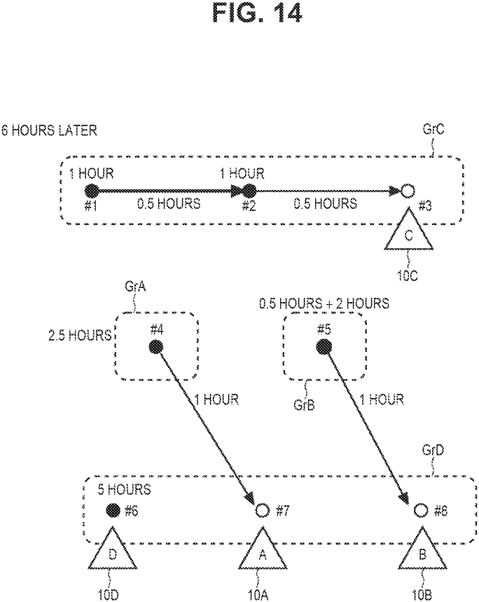

FIG. 14 illustrates the state of 6 hours later in the second specific example. The object 10C is processing the task 3 of the group GrC. Further, the object 10A is processing the task 7 of the group GrD. The object 10B is processing the task 8 of the group GrD. Further, the object 10D ends the processing of the task 6. Here, at this point, there are no unprocessed tasks that have not started the processing among the unprocessed tasks. Therefore, the reassigning unit 150 does not execute the reassigning processing on the object 10D. Therefore, the object 10D stands by at the position of the task 6.

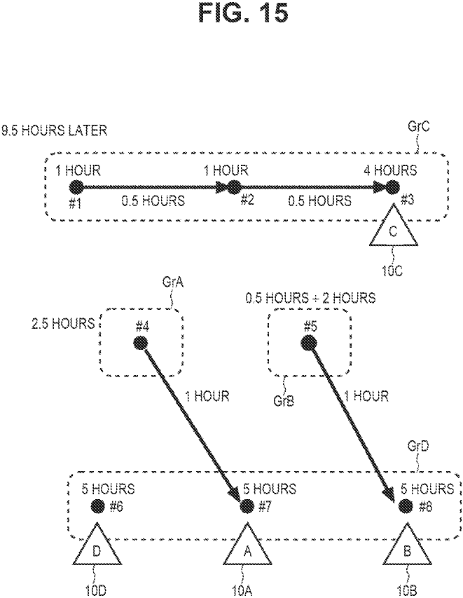

FIG. 15 illustrates the state of 9.5 hours later in the second specific example. Since the object 10C has ended, 8 hours later, the processing of the task 3, at this point, it is standing by at the position of the task 3. Further, the object 10A ends the processing of the task 7 of the group GrD. Further, the object 10B ends the processing of the task 8 of the group GrD. Therefore, the processing of all the tasks is completed.

In the second specific example, a condition for executing the reassigning according to the comparative example is “when the object 10 has completed the processing of all the tasks of which it is in charge, the object 10 is immediately rearranged to the group estimated to require the longest time for processing the tasks.” In this case, 1.5 hours later (see FIG. 12), when the object 10B ends the processing of the task 5, the object 10B can be rearranged to the task 3 having the shortest movement time from that position. In this case, 3.5 hours later (see FIG. 13), the object 10A ends the processing of the task 4 and completes the processing of the tasks of the group GrA. Further, the object 10C ends the processing of the tasks 1, 2. Here, since the object 10B is processing the remaining task 3 of the group GrC, there is no task to be processed by the object 10C in the group GrC. Therefore, the reassigning processing is executed on the objects 10A, 10C. In this case, the object 10A can be rearranged to the task 7 of the group GrD, and the object 10C can be rearranged to the task 8 of the group GrD. In this case, the movement time of the object 10C from the position of the task 2 to the position of the task 8 requires 1.5 hours or longer. Therefore, the start of the processing of the task 8 in the comparative example is delayed compared to the case of the first embodiment. Therefore, as compared with the case of the first embodiment, in the comparative example, the completion of the processing of all the tasks is delayed. Then, in the comparative example, the movement time of the object 10C is increased. In other words, in the comparative example, the entire processing time may be increased, and the movement time and movement distance may be increased.

Conversely, the control system 1 according to the first embodiment is configured to assign the object that has completed the processing of all the tasks in the assigned group to the tasks of which the processing has been ended in another group when the number of task completion objects is equal to or higher than the predetermined number. As such, it is highly possible for the task completion object to be reassigned to a task close thereto. Therefore, the control system 1 according to the first embodiment can efficiently process all the tasks.

As described above, when the processing status of the task satisfies a condition decided in advance, the control system 1 according to the first embodiment is configured to assign the task of which the processing has not been ended in another group to the object that has completed the processing of all the tasks of the assigned group. As such, it is highly possible for the object that has completed all the tasks to be rearranged to a group for assistance. Therefore, the control system 1 according to the first embodiment can efficiently process all the tasks.

Further, the control system 1 according to the first embodiment is configured to assign the object that has completed the processing of all the tasks in the assigned group to the task of which the processing has not been ended in another group when the number of task completion objects is equal to or higher than a predetermined number. The predetermined number can be decided according to, for example, a ratio of the number of the task completion objects to the total number of objects 10. With such a configuration, as in the above-described comparative example, it is possible to efficiently process all the tasks as compared with “when the object 10 has completed the processing of all the tasks of which it is in charge, the object 10 is immediately rearranged to the group estimated to require the longest time for processing the task.” In other words, in the first embodiment, the number of task completion objects equal to or higher than the predetermined number is rearranged in the unprocessed group all at once. As such, it is possible to restrict the increase in the movement time (the movement distance) of the object 10 and restrict the increase in the task processing time.

In particular, when the predetermined number is 50% of the total number of objects 10, the number of task completion objects is approximately the same as the number of unprocessed groups. Therefore, the task completion objects can be rearranged one by one in the unprocessed groups. As such, since the task processing time of each unprocessed group can be shortened, the task processing time can be shortened as a whole.

Further, the control system 1 according to the first embodiment is configured to execute control for causing the object 10 that has completed the processing of all the tasks of the assigned group to stand by in a predetermined state until the task is reassigned. As such, an unnecessary movement of the object 10 (the task completion object) is restricted. Therefore, it is possible to restrict the increase in the movement time and the movement distance of the object.

Further, the control system 1 according to the first embodiment is configured to execute the processing for dividing the tasks into the groups and assigning the respective groups to the respective objects before the objects 10 start the processing of the tasks. As such, the task assigning processing can be executed only once at the initial point. In other words, once the object 10 starts the processing of the task, a composition of the group is not changed. Here, when the assigning of the tasks is executed a plurality of times the composition of the group is changed, the processing of S110 will be executed a plurality of times, which may increase the calculation load and increase the calculation time. Conversely, with the configuration according to the first embodiment described above, it is possible to restrict the calculation load and restrict the increase in the calculation time in the control device 100, as compared with the case where the assigning of the tasks is executed a plurality of times and the composition of the group is changed.

Further, the control system 1 according to the first embodiment is configured to divide the tasks into the groups according to the estimated times required for the tasks. As such, it is possible to restrict the estimated required time from being biased between the groups. Therefore, it is possible to further restrict the increase in the time for processing the tasks as a whole.

### Second Embodiment

Next, a second embodiment will be described. Since the configuration of the control system 1 according to the second embodiment is substantially the same as that of the control system 1 according to the first embodiment illustrated in FIG. 1, the description thereof is omitted. Further, since the configuration of the control device 100 according to the second embodiment is substantially the same as that of the control device 100 according to the first embodiment illustrated in FIG. 3, the description thereof is omitted. The second embodiment differs from the first embodiment in terms of the trigger condition described above. In the second embodiment, the trigger condition is “a certain amount of time elapses since the task completion object has completed the processing of the task of which it is in charge.”

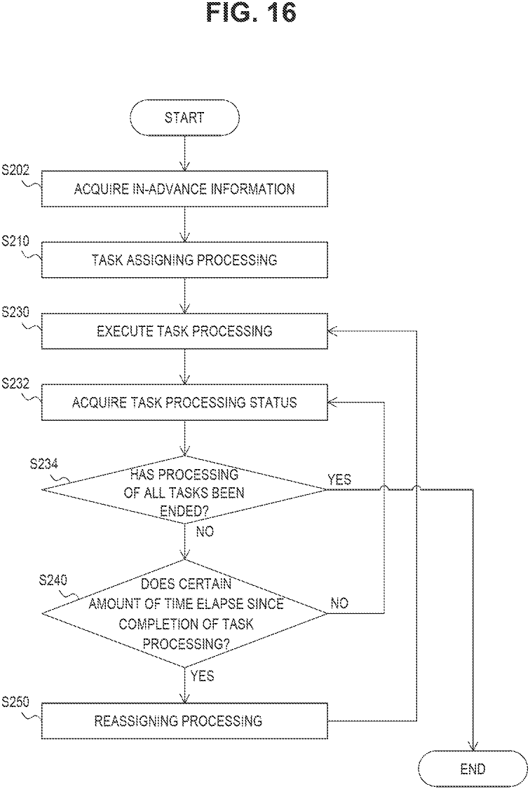

FIG. 16 is a flowchart illustrating a control method executed by the control system 1 according to the second embodiment. In the same manner as in S102, the in-advance information acquisition unit 112 acquires the in-advance information (step S202). In the same manner as in S110, the task assigning unit 120 executes the task assigning processing using the in-advance information (step S210). In the same manner as in S130, the task processing execution unit 130 controls each of the objects 10 such that the object 10 processes the tasks of the assigned group (step S230).

In the same manner as in S132, the task processing status acquisition unit 140 acquires the task processing status information (step S232). In the same manner as in S134, using the task processing status information, the reassigning unit 150 determines whether the processing of all the tasks has been ended (step S234). When the processing of all the tasks has been ended (YES in S234), the processing flow ends.

On the other hand, when the processing of all the tasks has not been ended (NO in S234), the reassigning unit 150 determines whether a certain amount of time elapses since the task completion object has completed the processing of the assigned task (step S240). The “certain amount of time” can be decided from characteristics of the task processing time. For example, when the actual task processing time is any one of a predetermined short time (for example, “10 minutes”) or a predetermined long time (for example, “1 hour”), the certain amount of time can be set according to the length of the short time. When the actual task processing time is “10 minutes” or “1 hour”, the certain amount of time may be set to 10 minutes.

When the certain amount of time does not elapse since the task completion object has completed the processing of the task of which it is in charge (NO in S240), the processing flow returns to S232. Then, the processes of S232 to S240 are repeated. On the other hand, when the certain amount of time elapses since the task completion object has completed the processing of the task of which it is in charge of (YES in S240), the above-described trigger condition for executing the reassigning is satisfied. In this case, the reassigning unit 150 executes the reassigning processing (step S250).

Specifically, the reassigning unit 150 assigns the unprocessed group to the task completion object, and assigns the unprocessed task in the unprocessed group. At this time, the reassigning unit 150 may rearrange the task completion object to the unprocessed group having the large number of unprocessed tasks from among the unprocessed groups. In other words, the reassigning unit 150 may assign the unprocessed tasks of the unprocessed group having the large number of unprocessed tasks to the task completion object. Alternatively, the reassigning unit 150 may rearrange the task completion object to the unprocessed group that includes many tasks having long actual task processing times.

When the reassigning processing is executed, the processing flow returns to S230. Then, the task processing execution unit 130 controls the task completion object such that the task completion object processes the task of the reassigned group (S230).

For example, in the example of FIG. 2, the tasks 1 to 4, the tasks 5 to 8, the tasks 9 to 11, and the tasks 12 to 14 are grouped into the groups A, B, C, D, respectively. The object 10C completes the processing of all the tasks of the group C at time t = t1. Further, the object 10B ends the processing of the tasks 8, 7 in this order, and is processing the task 6 at time t = t1. Further, the object 10D has ended the processing of the task 14 and is processing the task 13 at time t = t1.

Then, the actual task processing time is “10 minutes” or “1 hour”. In this case, the object 10C stands by for 10 minutes from time t = t1. Here, the actual task processing time of the task 6 is “10 minutes” and the actual task processing time of the task 13 is “1 hour”. In this case, at a point when the object 10C stood by for 10 minutes from time t = t1, the object 10B has ended the processing of the task 6 and is moving toward the final task 5. On the other hand, at that point, the object 10D is continuing the processing of the task 13. Therefore, the object 10C is rearranged to the task 12 of the group D.

Conversely, in the above case, when the object 10C is immediately rearranged to another group at time t = t1 without standing by for a certain amount of time (10 minutes), the object 10C may be rearranged to the task 5 of the group B. In this case, when the object 10C reaches the task 5, the object 10B may have already ended the processing of the task 6 and be processing the task 5. In this case, the rearranging of the object 10C is wasted. Therefore, by executing the reassigning processing after a certain amount of time elapses since the task completion object has completed the processing of the task of which it is in charge, it is possible to restrict the rearranging from being wasted. Therefore, the tasks can be efficiently processed.

In the second embodiment as well, the control system 1 is configured to assign the task of which the processing has not been ended another group to the task completion object when the processing status of the task satisfies the condition decided in advance. As such, it is highly possible for the object that has completed all the tasks to be rearranged to the group for assistance. Therefore, the control system 1 according to the second embodiment enables all the tasks to be efficiently processed.

### Modified Example

The present disclosure is not limited to the above embodiments, and can be modified as appropriate without departing from the scope of the disclosure. For example, the order of each step (each process) in the flowcharts described above can be changed as appropriate. Further, one or more of each step (each process) in the flowcharts described above can be omitted.

Further, the tasks may be dispersed in a virtual space. In this case, the task may correspond to, for example, process a workpiece, such as metal, by a processed machine, such as a lathe. In this case, the virtual space may be a space indicating a state of the processed machine instead of a coordinate space indicating a physical position. In other words, the virtual space may be a space in which one or more states (for example, a lathe angle, screw tightness) of the processed machine are used as coordinate axes. In this case, the object itself does not have to move its position in the actual space. In this case the object may be, for example, a processed machine, such as a lathe. In this case, the “state that can be changed in the space” of the object is a state that is adjusted during the processing by the processed machine. Then, this state can be different for each processed task. Therefore, each task corresponds to each state of the object.

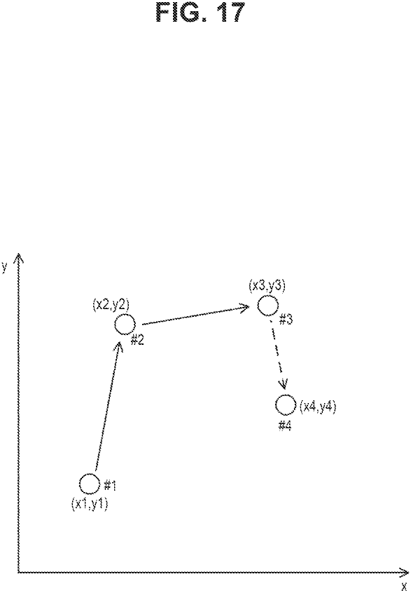

FIG. 17 is a diagram exemplifying the virtual space in which the tasks are dispersed according to a modified example. When a certain object (for example, a processed machine) processes a workpiece, a state x and a state y of the object are adjusted, and in those states (x,y), the task of processing the workpiece is executed. For example, the state x may be the lathe angle and the state y may be the screw tightness. Further, the object also changes the state and processes a different task. A time required for changing the state corresponds to the movement time required for moving the state within the virtual space. Further, the time to process a task in a certain state corresponds to the task processing time.

Then, the task 1 that can be processed in states (x1,y1), the task 2 that can be processed in states (x2,y2), and the task 3 that can be processed in states (x3,y3) are assigned to the object A. In this case, the object A processes the task 1 in the states (x1,y1). Upon ending the processing of the task 1, the object A changes the states and processes the task 2 the in states (x2,y2). Upon ending the processing of the task 2, the object A changes the states and processes the task 3 in the states (x3,y3). As such, the object A completes the processing of the assigned task.

At this time, the task 4 assigned to another object B is the unprocessed task. In this case, when the trigger condition described above is satisfied, the object A can change its states to states (x4,y4) corresponding to the task 4 and process the task 4.

Further, in the above-described embodiments, before the objects start the processing of the tasks, the task assigning unit 120 executes the processing for dividing the tasks into the groups and assigning the respective groups to the respective objects. In other words, in the above-described embodiments, when the task assigning unit 120 divides the tasks into groups, the compositions of the groups is not changed while the objects are processing the tasks. However, the control system 1 according to the present embodiment is not limited to such a configuration. Grouping may be executed again and the compositions of the groups may be changed while the objects are processing the tasks. For example, for a task of a certain group, when it is appropriate to consider that the actual processing time of the unprocessed task of the group is longer (or shorter) than the estimated processing time thereof while the object is processing the tasks, the grouping may be re-executed accordingly. However, in this case, it is necessary to decide whether to re-execute the grouping by comparing a calculation cost (a calculation load and a calculation time) required for grouping (the task assigning processing) with a benefit of re-executing the grouping.

Further, in the above-described embodiments, the task assigning processing is executed based on the estimated task processing time acquired in advance for each task, but the configuration is not limited thereto. The present disclosure is applicable even when the estimated task processing time of each task is unknown. When the estimated task processing time of each task is not known, the task assigning processing may be executed by assuming that the estimated task processing times of all the tasks are the same predetermined processing time.

Further, in the above-described embodiments, a difference between the estimated movement time and the actual movement time is not considered. However, even when the estimated movement time differs from the actual movement time, the present disclosure is applicable in the same manner as when there is no difference between the estimated task processing time and the actual task processing time. Further, in the above-described embodiments, it is not described that the position of the object is changed while the object is processing the task. However, in the system according to the present embodiment, the position (state) of the object may be changed while the object is processing the task. For example, when the object is a taxi and the task is taxi passengers, the object may process the next tasks from a place of transportation after transporting the passengers.

The programs described above include an instruction group (or software code) that, when read into a computer, causes the computer to execute one or more functions described in the embodiments. The programs may be stored in a non-transitory computer-readable medium or tangible storage medium. An example of a computer-readable medium or a tangible storage medium includes a RAM, a ROM, a flash memory, solid-state drive (SSD), or other memory technology, a CD-ROM, a digital versatile disk (DVD), a Blu-ray^{®} disc, or other optical disc storage, a magnetic cassette, a magnetic tape, a magnetic disc storage, or other magnetic storage device, but the example is not limited thereto. The programs may be transmitted on a transitory computer-readable medium or a communication medium. An example of a transitory computer-readable medium or a communication medium includes electrical, optical, acoustic, or other forms of propagated signals, but the example is not limited thereto.

What is claimed is us:

1. A control system comprising:
a task assigning unit configured to divide a plurality of tasks dispersed in a space into a plurality of groups each including one or more tasks and assign the respective groups to a plurality of respective objects of which states are changeable in the space;
a task processing execution unit configured to execute control for causing the respective objects to process the tasks of the assigned groups; and
a reassigning unit configured to, when a processing status of a task satisfies a condition decided in advance, assign a task of which processing is not ended in another group to an object that completes the processing of all the tasks of the assigned group.

2. The control system according to claim 1, wherein the task assigning unit is configured to, before the object starts processing of the task, execute processing for dividing the tasks into the groups and assigning the respective groups to the respective objects.

3. The control system according to claim 1, wherein the reassigning unit is configured to, when the number of objects that complete the processing of all the tasks of the assigned group is equal to or higher than a predetermined number, assign the task of which the processing is not ended in another group.

4. The control system according to claim 3, wherein the task processing execution unit is configured to execute control for causing the object that completes the processing of all the tasks of the assigned group to stand by in a predetermined state until a task is reassigned.

5. The control system according to claim 1, wherein the reassigning unit is configured to, when a certain amount of time elapses since the object completes the processing of all the tasks of the assigned group, assign the task of which the processing is not ended in another group to the object.

6. The control system according to claim 1, wherein the task assigning unit is configured to divide the tasks into the groups according to an estimated time required for the task.

7. The control system according to claim 6, wherein the estimated time required for the task is a total of an estimated movement time from a current position of the object to the task and an estimated task processing time estimated to be required for the object to process the task.

8. A control method comprising:
dividing a plurality of tasks dispersed in a space into a plurality of groups each including one or more tasks and assigning the respective groups to a plurality of respective objects of which states are changeable in the space;
executing control for causing the respective objects to process the tasks of the assigned groups; and
assigning, when a processing status of the task satisfies a condition decided in advance, a task of which processing is not ended in another group to an object that completes processing of all the tasks of the assigned group.

9. A non-transitory storage medium storing instructions that are executable by one or more processors and that cause the one or more processors to execute functions comprising:
dividing a plurality of tasks dispersed in a space into a plurality of groups each including one or more tasks and assigning the respective groups to a plurality of respective objects of which states are changeable in the space;
executing control for causing the respective objects to process the tasks of the assigned groups; and
assigning, when a processing status of the task satisfies a condition decided in advance, a task of which processing is not ended in another group to an object that completes processing of all the tasks of the assigned group.
